(19) United States
(12) Patent Application Publication
(10) Pub. No.: US 2010/0299272 A1
(43) Pub. Date: Nov. 25, 2010

(54) WORKFLOW STATUS TRACKING AND REPORTING

(75) Inventors: Joseph Lyons, Springfield, VA (US); Darren Collins, Wichita, KS (US)

Correspondence Address: Muncy, Geissler, Olds & Lowe, PLLC, 4000 Legato Road, Suite 310, FAIRFAX, VA, 22033, US

(73) Assignee: FORMATTA CORPORATION, Fairfax, VA (US)

(21) Appl. No.: 12/681,667

(22) PCT Filed: Oct. 3, 2008
(86) PCT No.: PCT/US2008/078802

§ 371 Date: Aug. 13, 2010

Related U.S. Application Data
(60) Provisional application No. 60/977,308, filed on Oct. 3, 2007.

(51) Int. Cl. G06Q 10/00

(52) U.S. Cl. 705/301

(57) ABSTRACT

A system and method for tracking a status of a portable electronic file is provided. The system includes a workflow server having at least a rules engine and a tracking engine, the workflow server being configured to update a status tracker that is embedded into the portable electronic file, and at least one end user connected via a network to the workflow server. The end user is capable of receiving and submitting the portable electronic file to and from the workflow server, whereby the workflow server is configured to track at least a submission of the portable electronic file. Upon actuation of the embedded status tracker within the portable electronic file by the end user, a status report indicating the status of the portable electronic file is displayed to the end user.

This nonprovisional application claims priority to U.S. Provisional Application No. 60/977,308, which was filed on Oct. 3, 2007, and which is herein incorporated by reference.

### BACKGROUND OF THE INVENTION

1. Field of the Invention

The present invention relates to a system and method for facilitating a reporting on a status of a portable document from the document itself via a communication between the document and a centralized server computer that tracks the status of that document on a submissions/actions basis in a disconnected environment.

2. Description of the Background Art

With the growing popularity of electronic communication, more and more employees, customers, vendors, etc. are sending and receiving emails, faxes, and digital images. A number of companies make workflow automation products that allow a company to create a workflow model and components and then to use this product as a way to manage the handling of work within the workflow environment. Workflow processes typically describe the automation of business procedures or “workflows” during which documents, information or tasks are passed from within a workflow environment from one participant to another in a way that is governed by rules or procedures. For example, a company could use a workflow process to automate normally time-consuming tasks, such as order processing, refunds, and merchandise tracking. Workflow software can be configured to handle such tasks and guarantee that all of the data will get to the right places.

U.S. Pat. No. 7,221,377, which is herein incorporated by reference, describes a method for displaying information relating to a workflow, gathering statistical information relating to the execution of the workflow, and displaying the gathered information. U.S. Publication No. 2008/0040191, which is herein incorporated by reference, describes a method for monitoring and analyzing a system activity to identify an occurrence of an incident, assigning a workflow process to an incident, applying the assigned workflow process to remediate the incident, and tracking and graphically displaying the status of the workflow process.

Conventional workflow applications, however, require that the workflow process remain within a workflow environment that is specific to that environment. In other words, in order to track the status of a document specific workflow software must be installed for each user within the workflow environment.

### SUMMARY OF THE INVENTION

It is therefore an object of the present invention to provide a system for tracking a status of a portable electronic file. The system including a server configured to update a status tracker that is embedded into the portable electronic file, and at least one end user connected via a network to the server, the end user capable of receiving and/or submitting the portable electronic file at least to and from the server, the server being configured to track at least a submission of the portable electronic file. Upon actuation of the embedded status tracker within the portable electronic file by the end user, a status report indicating the status of the portable electronic file is displayed to the end user.

It is also an object of the present invention to provide a method for tracking a status of a portable electronic file. The method includes embedding a status tracker into the portable electronic file, providing at least one end user with the portable electronic file, the end user being configured to selectively alter the portable electronic file, updating a server such that the server tracks a status of the portable electronic file upon submission of the portable electronic file by the end user, and displaying a status report indicating the status of the portable electronic file when the end user actuates the embedded status tracker.

It is also an object of the present invention to provide a portable electronic file having file content that can be selectively altered by an end user, and an embedded status tracker that includes a tracking component, engine connection data, and a status report actuator. The tracking component includes a unique identifier for identifying the portable electronic file to a server. The engine connection data contains information on locating the server within a network, and, upon actuation of the status report actuator, a status report indicating the status of the portable electronic file is displayed to the end user.

In view of these objects, it should be appreciated that according to an embodiment, the need for specialized workflow specific software to access the status of the portable electronic file within the workflow process is eliminated.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a block diagram of a conventional workflow environment;

FIG. 2 is a block diagram of a workflow status tracking system according to an exemplary embodiment of the present invention;

FIG. 3 is a block diagram of a portable electronic file according to an embodiment of the present invention;

FIG. 4 is a block diagram of a status report according to an embodiment of the present invention; and

FIG. 5 is a flow chart of an exemplary embodiment.

### DETAILED DESCRIPTION

In the following description, like reference numerals indicate like components. Further, in this application, the words “object” and “workflow object” are representative types of portable file or files, such as, but not limited to, documents, forms, word processing documents, spreadsheets, diagrams, presentations, charts, and any other type of electronic file that can be transferred from a user to a user or a system to a system, or included in a workflow, approval, or similar business process.

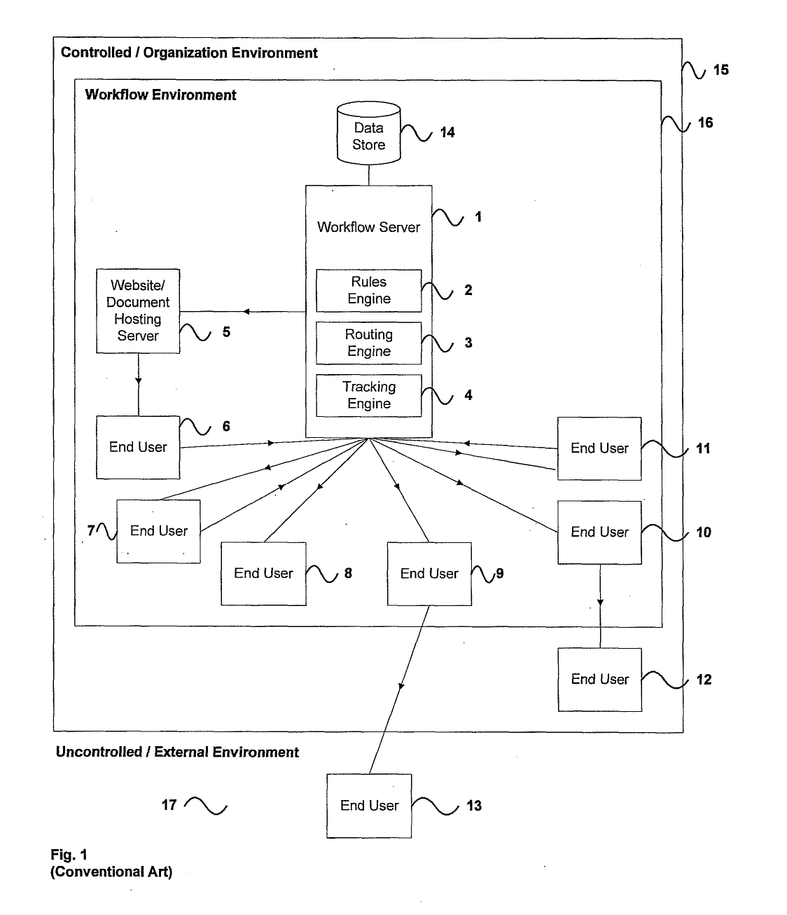

Referring to FIG. 1, there is illustrated a block diagram of a conventional workflow environment 16. Within the workflow environment 16 there typically is a website/document hosting server 5, a workflow server 1 having a rules engine 2, a routing engine 3, and a tracking engine 4, a data store 14, and a plurality of end users 6-11.

The rules engine 2 can be a software system that executes one or more business rules, which can describe the operations, definitions and constraints that apply to an organization. The routing engine 3 monitors workflow states and coordinates the routing of activities for a process. In other words, the routing engine 3 monitors a change in a workflow state, such as the completion of a workflow activity and directs a document to a subsequent workflow process. The tracking engine 4 tracks the activity or document to facilitate recordation so that it can be determined at what stage within the workflow process that the activity or document is.

The website/document hosting server 5 is provided to enable the end user 6 to download a portable document, such as a fillable form. Once the end user 6 completes their task, the portable electronic file is then provided to the workflow server 1, where based upon particular rules, the portable document is then routed to further end users 7-10. It is noted that the end users can be either inside the workflow environment 16 or outside in an uncontrolled external environment 17. The end user can also include computer and computer systems. In order to track the status of the portable document, the end users 6-11 may determine the status or location of the portable document. However, in order for the end users 6-11 to be able to track the portable document in the conventional system, these end users 6-11 must have additional software installed specific to the workflow environment 16 and must be within the workflow environment 16.

Thus, according to the conventional art, an end user 12, who is within the organization environment 15 or an end user 13 who is not within the organization environment 17 cannot track the status of the portable document, although they may be capable of receiving such, because they do not have the specific workflow environment software installed.

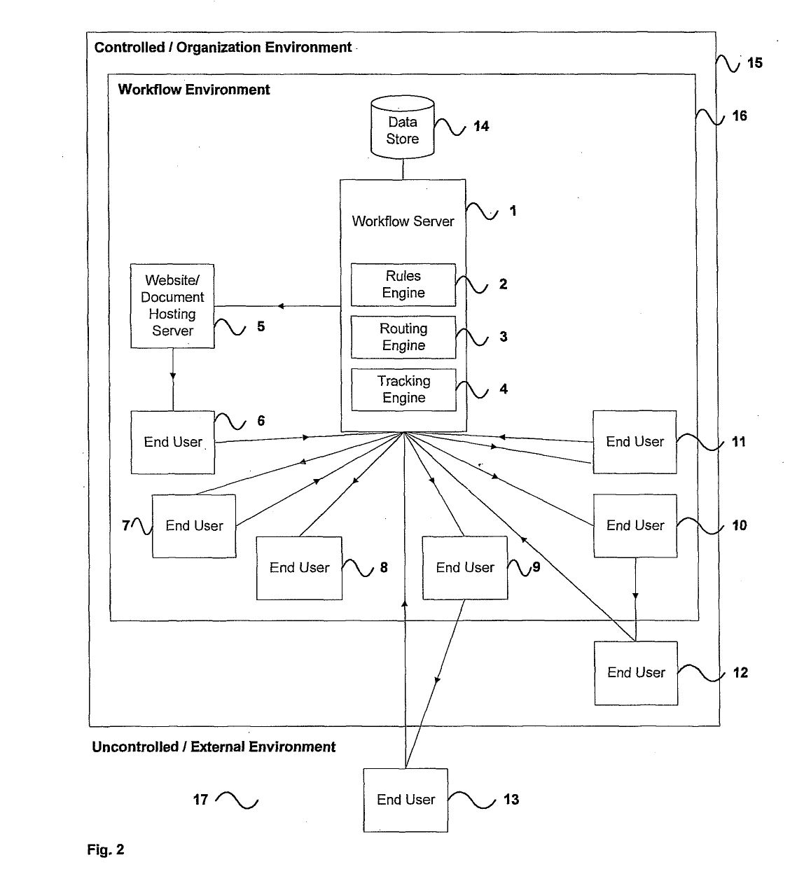

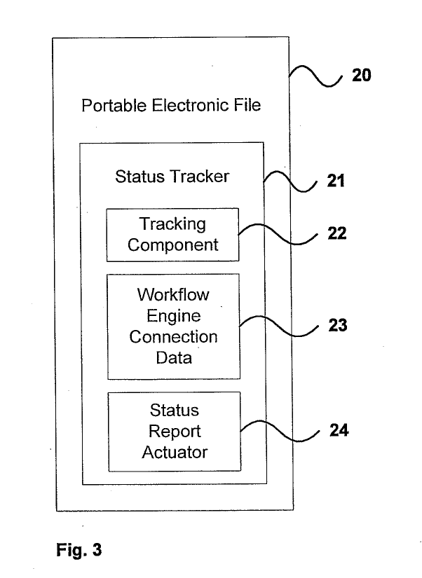

FIG. 2 illustrates a block diagram of a workflow status tracking system according to an exemplary embodiment of the present application, and FIG. 3 illustrates a block diagram of a portable electronic file 20 according to an embodiment of the present invention.

According to an embodiment of the present invention, the portable electronic file 20 includes a an embedded status tracker 21 that includes a tracking component 22 that identifies the portable electronic file 20 to the tracking engine 4 of the workflow server 1. The tracking component 22 may be a unique identifier that is specific to the portable electronic file 20 and may be provided to the portable electronic file 20 upon upload or submission to the document hosting server 5 or upon download by, for example, the end user 6. Further, status tracker 21 includes a workflow engine connection data 23 and a status report actuator 24. The workflow engine connection data 23 provides details to point to the workflow server 1 within a network. The status report actuator 24 initiates communication between the embedded status tracker 21 and the workflow server tracking engine for the provision of details to the end user as to the status of the portable document.

In an example, a fillable form 20, such as an expense report, that has the status tracker 21 embedded therein, is retrieved by the end user 6 from the document hosting server 5 upon a request from the end user 13 who may be connected to the workflow environment 16 via the internet, and is then directed from the end user 6 to the end user 13 via the workflow server 1. It is noted that end user 13 may also directly retrieve the portable electronic file 20 from the document hosting server 5. Upon completion of the expense report by the end user 13, the expense report is submitted to the workflow server 1 and is then distributed according to, for example, predetermined workflow processes, for example, the expense report can then be routed to end user 11 for final approval. This submission to or from any end user or the workflow server 1 may be done via secured or encrypted communications methods known to one skilled in the art. Thereafter, the end user 13 can determine the status of the expense report upon actuation of the embedded status report actuator 24 and can thereby determine if end user 11 has approved the expense report. Thus, end user 13 does not require any additional workflow specific software that is separate from the portable electronic file or files 20 in order to obtain the status of the portable electronic file 20. In other words the portable electronic file 20 can be emailed and used by any end user thereby eliminating the need for specialized workflow specific software to access the status of the portable electronic file 20 within the workflow process.

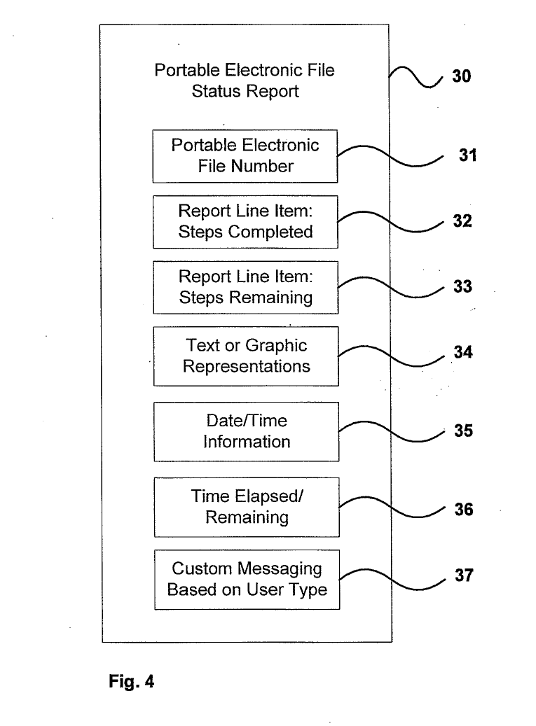

The display of the workflow status information can be textual or graphical. Referring to FIG. 4, there is shown is a block diagram of a status report according to an embodiment of the present invention. The status information can be a high level, e.g., percentage completion, or at a granular level, such that the workflow can be traced as individual workflow operations or actions are completed (success, failure, pending, in-process, etc.). Additional information about each workflow can also be captured and reported, such as portable electronic file number 31, the steps completed 32, the operators involved, date or time information 35, action type history, etc. Additional information about each workflow can also be reported, such as incomplete, e.g., future contingent, processing steps, actors, and events. Information can also include ad hoc information entered into the document in the course of the workflow process as well as structure information provided programmatically or otherwise when the workflow process was developed (independent of the specifics of any particular instance of a workflow process). Information can also include branched distributions of a document in a workflow where further ad hoc actions are reported and collected for all subsequent actions performed on the distributed document.

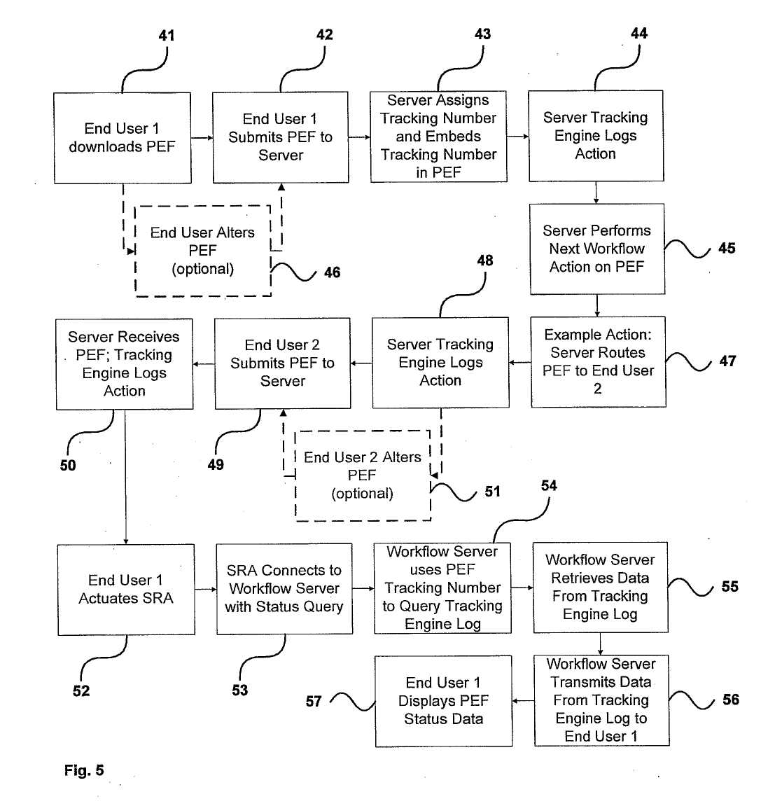

FIG. 5 is a flow chart illustrating a workflow process according to an embodiment of the present invention. An end user downloads the portable electronic file (PEF) 20 in step 41 and submits the file to the workflow server 1 in step 42. In step 43, the workflow server 1 assigns a tracking number and embeds the tracking number in the tracking component 22 of the status tracker 21 within the portable electronic file 20. This tracking number can also be embedded within the portable electronic file 20 prior to downloading. The server tracking engine 4 begins logging actions undertaken to the portable electronic file 20, and the workflow server 1 then performs the next action according to, for example, a rule provided by the rules engine 2. For example, the workflow server 1 may route the portable electronic file to a second end user, as illustrated in step 47, whereby the tracking engine 4 also logs this action. Upon completion of the task, the second end user submits the document either to another end user or back to the workflow server 1, whereby the tracking engine 4 logs the action upon receipt of the portable electronic file 20, as noted in step 50.

If the first end user decides that they want to know the status of the portable electronic file, e.g. has the second end user altered or submitted the file (steps 49 and 51), the first end user opens the portable electronic file 20 in its native software application and actuates the embedded status tracker 21, which then facilitates connection with the workflow server 1. The workflow server 1, via the tracking component 22, which can be a unique identifier, queries the tracking engine 4 and retrieves data relating to the portable electronic file status report 30. Thereafter, the workflow server 1 transmits this data to the first end user, whereby the data is then displayed to the first end user, as shown in step 57.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A system for tracking a status of a portable electronic file, the system comprising:
a server configured to update a status tracker that is embedded into the portable electronic file; and
at least one end user connected via a network to the server, the end user capable of receiving and/or submitting the portable electronic file at least to and from the server, the server being configured to track at least a submission of the portable electronic file,
wherein, upon actuation of the embedded status tracker within the portable electronic file by the end user, a status report indicating the status of the portable electronic file is displayed to the end user.

2. The system according to claim 1, wherein the server further comprises a routing engine for monitoring workflow states and coordinating routing of activities for the portable electronic file, or further comprises a rules engine for executing one or more business specific rules that describes at least an operation that is specific to an organization.

3. The system according to claim 1, further comprising a document hosting server for providing the portable electronic file to the end user.

4. The system according to claim 1, further comprising a tracking engine for tracking the portable electronic file to facilitate determination at what stage within a business process the portable electronic file is.

5. The system according to claim 1, further comprising a tracking engine for tracking the portable electronic file based on at least a tracking identifier that is unique to the portable electronic file.

6. The system according to claim 1, wherein the status report being displayed to the end user includes a level of completion, location of the portable electronic time; distribution information, date and time of completion of a business process, and/or other information.

7. The system according to claim 1, wherein information required for generating the status report indicating the status of the portable electronic file is provided to the end user solely on the basis of the embedded status actuator.

8. The system according to claim 1, wherein, to display the status report indicating the status of the portable electronic file, no specialized workflow specific software external to the portable electronic file is needed by the end user.

9. The system according to claim 1, wherein the status tracker that is embedded in the portable electronic file further comprises a tracking component that includes a tracking identifier that is unique to the portable electronic file.

10. The system according to claim 1, wherein, when the portable electronic file is forwarded directly from a first end user to a second end user, the embedded status tracker tracks the status thereof and provides such to the server when the portable electronic file is submitted to the server.

11. The system according to claim 1, wherein, when the portable electronic file is forwarded from a first end user directly to a second end user and subsequently to a third end user, the third end user, upon actuating the embedded status actuator, is provided with a status report based on submissions of the portable electronic file to the server.

12. The system according to claim 1, wherein the server is a workflow server having a rules engine, a routing engine, and a tracking engine.

13. A method for tracking a status of a portable electronic file, the method comprising:
embedding a status tracker into the portable electronic file;
providing at least one end user with the portable electronic file, the end user being configured to selectively alter the portable electronic file;
updating a server such that the server tracks a status of the portable electronic file upon submission of the portable electronic file by the end user; and
displaying a status report indicating the status of the portable electronic file when the end user actuates the embedded status tracker.

14. The method according to claim 13, wherein the portable electronic file is provide to the end user via a document hosting server.

15. The method according to claim 13, wherein the server is a workflow server provided within a workflow environment.

16. The method according to claim 13, wherein the status report is displayed via software that is not specific to the workflow environment.

17. The method according to claim 13, wherein the server is updated only when the portable electronic file is submitted to the server.

18. A portable electronic file comprising:
file content that can be selectively altered by an end user; and
an embedded status tracker that includes a tracking component, engine connection data, and a status report actuator,
wherein the tracking component includes a unique identifier for identifying the portable electronic file to a server,
wherein the engine connection data contains information on locating the server within a network, and
wherein, upon actuation of the status report actuator, a status report indicating the status of the portable electronic file is displayed to the end user.
